(19) United States
(12) Patent Application Publication
(10) Pub. No.: US 2016/0354911 A1
(43) Pub. Date: Dec. 8, 2016

(54) POWER TOOL

(71) Applicant: MAKITA CORPORATION, Anjo-shi (JP)

(72) Inventors: Yonosuke AOKI, Anjo-shi (JP); Hikaru SUNABE, Anjo-shi (JP)

(73) Assignee: MAKITA CORPORATION, Anjo-shi (JP)

(21) Appl. No.: 15/168,846

(22) Filed: May 31, 2016

(30) Foreign Application Priority Data
Jun. 5, 2015 (JP) 2015-115243

(51) Int. Cl. B25F 5/00; H02K 7/14; H02K 11/20

(52) U.S. Cl. CPC B25F 5/00; H02K 11/20; H02K 7/145

(57) ABSTRACT

It is an object of the invention to provide a further rational technique in the arrangement structure of members of a power tool which is configured to be capable of detecting behavior during operation. A representative power tool has a body 101 that has a driving mechanism housing region 101a for housing a driving mechanism 120 and a controller housing region 101b for housing a controller 140, a first sensor 171 for detecting behavior of the body 101 and a second sensor 172 for detecting behavior of the body 101. The first sensor 171 and the second sensor 172 are arranged in the driving mechanism housing region 101a and the controller housing region 101b, respectively.

### TECHNICAL FIELD

The present invention relates to a power tool which performs a prescribed operation by rotationally driving a tool accessory.

### BACKGROUND ART

Japanese Unexamined Patent Application Publication No. 2000-263304 discloses a hand-held hammer drill having a structure for detecting the behavior of a hammer drill during operation by a plurality of sensors. More specifically, this hammer drill is configured such that a driving motor is de-energized so as to suppress inadvertent swing of the hammer drill caused by a so-called blocking phenomenon of a tool bit when a plurality of acceleration sensors detect occurrence of the blocking phenomenon.

### SUMMARY OF THE INVENTION

### Problems to be Solved by the Invention

Above-described known power tool is capable of developing an effect of shortening duration of wobbling of the hammer drill. Further improvement is however desired in order to efficiently arrange a plurality of sensors in a power tool.

Accordingly, it is an object of the present invention to provide a further rational technique in the arrangement structure of members of a power tool which is configured to be capable of detecting behavior during operation.

### BRIEF DESCRIPTION OF THE INVENTION

Above-described problem can be solved by the proposed invention. According to the invention, a representative power tool according to the present invention, which performs a prescribed operation by rotationally driving a tool accessory, is provided with a driving mechanism. The driving mechanism has a chuck that can rotate while holding the tool accessory, a driving motor, a power transmitting mechanism that transmits rotation of the driving motor to the chuck, and a switch that is operated via a trigger which is manually operated by a user. The chuck can be configured such that the tool accessory is removably coupled to the chuck. Further, the driving motor can be driven by a battery, and in this case, the power tool can be provided with a battery mounting part. The power transmitting mechanism can be formed by a speed reducing mechanism, or more specifically, a planetary gear mechanism Further, the trigger can be provided on a handgrip to be held by a user.

The power tool further has a controller for controlling driving of the driving motor. The controller has a printed circuit board and a central processing unit mounted on the printed circuit board. The controller is capable of controlling the amount of electric current supply to the driving motor when the user operates the trigger. Further, the controller is capable of performing controls involved in operating various functions of the power tool. The functions of the power tool include changeover of the rotation speed of the tool accessory, lighting of a light-emitting element for illuminating a workpiece, changeover of the rotating direction of the tool accessory, and display of remaining battery charge.

The power tool further has a body including a driving mechanism housing region for housing the driving mechanism, and a controller housing region for housing the controller. The driving mechanism housing region can house components of the above-described driving mechanism in various kinds of arrangement. For example, the driving mechanism housing region can house the driving motor, the power transmitting mechanism and the chuck such that rotation axes of the driving motor, the power transmitting mechanism and the chuck are aligned in a line. Further, the driving mechanism housing region does not refer only to a region for housing the driving mechanism, but can refer to a region including a peripheral region of the driving mechanism. Similarly, the controller housing region can refer to a region including a peripheral region of the controller. Further, in the power tool, the driving mechanism housing region and the controller housing region are formed away from each other. In this sense, an intermediate region can be formed between the driving mechanism housing region and the controller housing region. Therefore, when the driving mechanism housing region is formed in an upper part of the power tool, the controller housing region can be formed in a lower part of the power tool. Further, in the power tool, the battery mounting part can be provided in the lowest part of the body. In this case, it can be said that the controller housing region is arranged adjacent to the battery mounting part.

The power tool further has a first sensor for detecting prescribed behavior of the body and a second sensor for detecting prescribed behavior of the body. The prescribed behavior of the body detected by the first sensor and the prescribed behavior of the body detected by the second sensor may be the same or different from each other. This behavior includes behavior of the body around the rotation axis of the chuck, behavior of the body in a longitudinal direction, and vibration and impact applied to the body. An acceleration sensor can be used as the first and second sensors. An acceleration sensor of a uniaxial detection type or a multiaxial detection type can be appropriately used as the acceleration sensor.

The above-described behavior of the body can be detected by the first sensor or the second sensor. In this case, the controller can operate the behavior of the body detected by the first sensor and the behavior of the body detected by the second sensor and detect the behavior of the whole body.

Alternatively, the first sensor or the second sensor may detect only an inclination angle of the body to the earth's axis. In this case, the controller can detect the behavior of the body in the driving mechanism housing region or the controller housing region based on the inclination angle detected by the first sensor or the second sensor. In this case, the controller can further operate the behavior of the body in the driving mechanism housing region and the behavior of the body in the controller housing region and detect the behavior of the whole body.

The controller has a central processing unit provided with a storage part, a comparison operation part and a current shutoff part. For example, when the power tool smoothly performs an operation, the storage part can store information to be detected by the first sensor and the second sensor. The comparison operation part compares signals obtained from the first and second sensors during operation with the information stored in the storage part and determines whether the power tool is in a stable state or in an unstable state. When the comparison operation part determines that the power tool is in the unstable state, the current shutoff part de-energizes the driving motor. Therefore, for example, when a blocking state occurs, the driving motor can be stopped, so that wobbling of the power tool can be stopped in a short time.

The first sensor and the second sensor are disposed in the driving mechanism housing region and the controller housing region, respectively. As describe above, since the driving mechanism housing region and the controller housing region are arranged in a position away from each other, the controller can accurately determine the behavior of the whole body.

Further, with the structure in which the first sensor and the second sensor are disposed in the driving mechanism housing region and the controller housing region, respectively, it is not necessary to specially provide a sensor arrangement region. Therefore, the structure of the body can be prevented from being increased in size.

The power tool which performs a prescribed operation by rotationally driving the tool accessory includes an electric driver which performs a screw tightening operation, an electric drill which performs a drilling operation, and an electric driver drill which is configured to be capable of performing both the screw tightening operation and the drilling operation.

In another aspect of the power tool according to the present invention, the controller may have a controller housing that houses a controller circuit board. In this case, the second sensor can be housed in the controller housing. More specifically, the second sensor can be mounted on the controller circuit board. Alternatively, the second sensor may be disposed not on the controller circuit board, but within the controller housing.

According to the power tool of this aspect, the second sensor can be disposed within the existing controller housing, so that the power tool can be prevented from being increased in size due to the arrangement structure of the second sensor.

In another aspect of the power tool according to the present invention, the driving motor can be a brushless motor. The brushless motor has a stator having a coil, a rotor that can rotate with respect to the stator and has a magnet, and a motor circuit board.

The motor circuit board is provided on the stator. Further, a rotation detecting element for detecting a position of the magnet and a switching element for supplying current to the coil based on a detection result of the rotation detecting element are mounted on the motor circuit board. In this case, the first sensor can be mounted on the motor circuit board.

According to the power tool of this aspect, with the structure in which the first sensor can be mounted on the existing motor circuit board of the brushless motor, the power tool can be prevented from being increased in size due to the arrangement structure of the first sensor.

In another aspect of the power tool according to the present invention, the switch can have a switch housing that houses a switch circuit board. In this case, the first sensor can be housed in the switch housing. More specifically, the first sensor can be mounted on the switch circuit board. Alternatively, the first sensor may be disposed not on the switch circuit board, but within the switch housing.

According to the power tool of this aspect, with the structure in which the first sensor can be disposed within the existing switch housing, the power tool can be prevented from being increased in size due to the arrangement structure of the first sensor.

In another aspect of the power tool according to the present invention, the first sensor can be disposed within a first sensor arrangement space formed between the switch and the power transmitting mechanism. Further, the first sensor arrangement space refers to a space for arranging the first sensor in the body. The switch which is operated by a trigger operation is arranged adjacent to the trigger in the body. With this structure, in the body, a prescribed space is formed between the switch and the power transmitting mechanism.

According to the power tool of this aspect, the prescribed space formed between the switch and the power transmitting mechanism can be configured as the first sensor arrangement space, so that the power tool can be prevented from being increased in size due to the arrangement structure of the first sensor.

In another aspect of the power tool according to the present invention, the first sensor can be mounted on a first sensor substrate. As described above, when the first sensor is mounted on the controller circuit board or the switch circuit board, the controller circuit board or the switch circuit board also serves as the first sensor substrate.

Further, the first sensor may also be mounted on a printed circuit board having components related to the above-described prescribed functions of the power tool. In this case, the printed circuit board also serves as the first sensor substrate.

Moreover, a printed circuit board on which only components related to the first sensor are mounted may also be configured as the first sensor substrate. In this case, the first sensor substrate may also be referred to as an exclusive functional component mounting substrate for the first sensor.

According to the power tool of this aspect, the first sensor substrate can be formed in accordance with a desired arrangement.

According to the present invention, a further rational technique can be provided in the arrangement structure of members of a power tool which is configured to be capable of detecting behavior during operation.

### BRIEF DESCRIPTION OF THE DRAWINGS

FIG. 1 is a sectional side view showing a driver drill according to a first embodiment of the present invention.

FIG. 2 is an enlarged sectional view showing an essential part of a power transmitting mechanism.

FIG. 3 is an explanatory drawing for illustrating the outline of a stator.

FIG. 4 is a sectional side view showing a driver drill according to a second embodiment of the present invention.

FIG. 5 is a sectional side view showing a driver drill according to a third embodiment of the present invention.

### DETAILED EXPLANATION OF EMBODIMENTS OF THE INVENTION

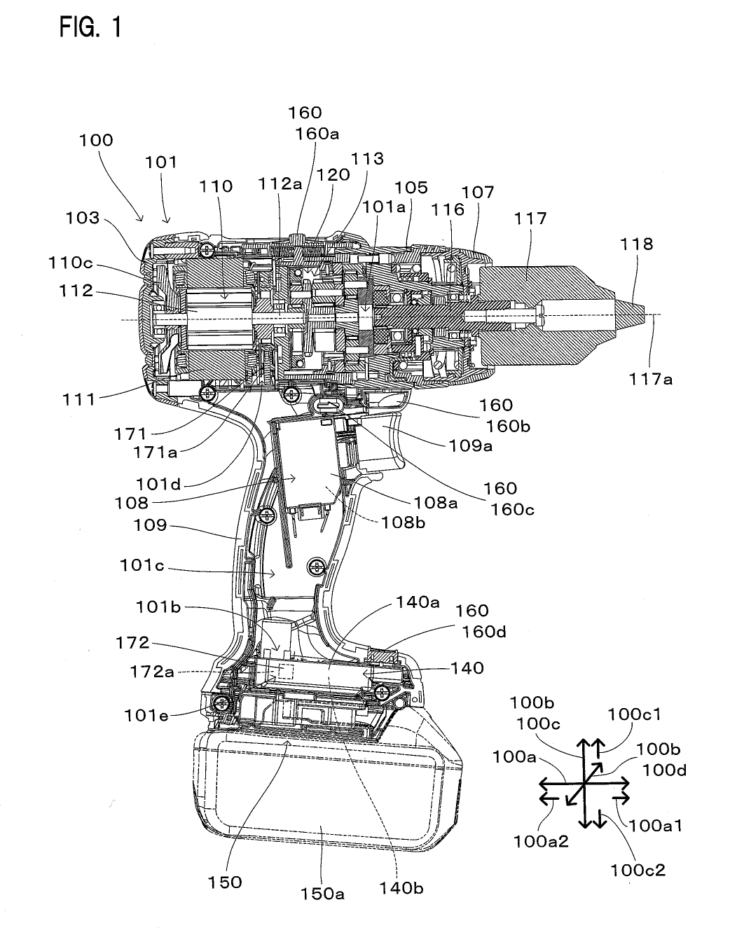

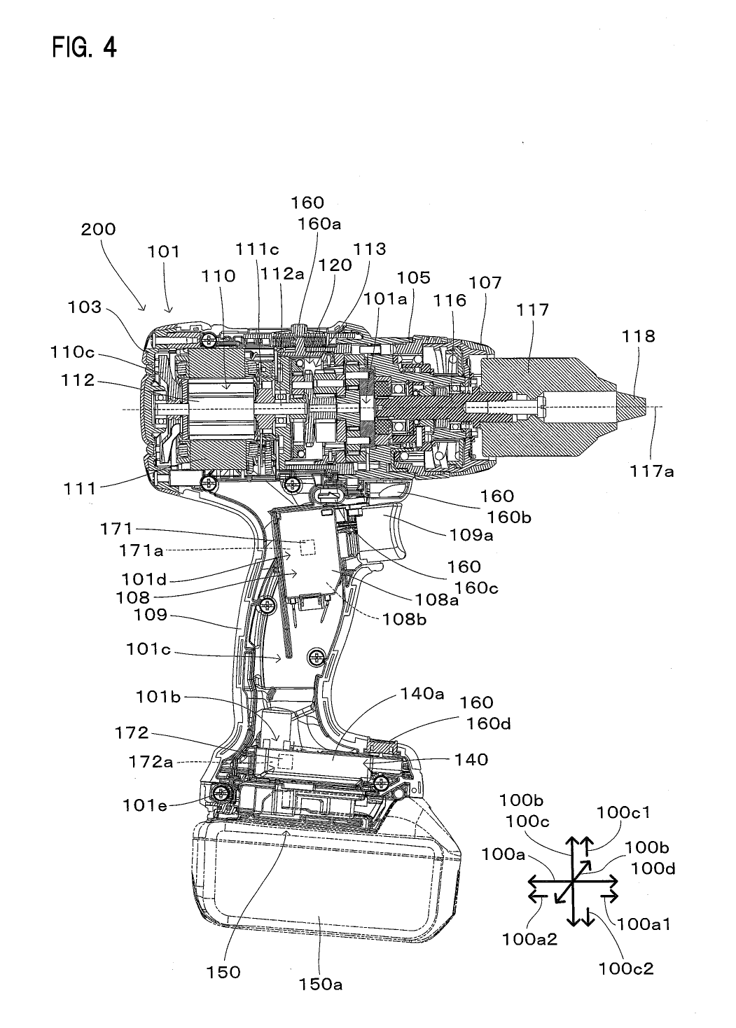

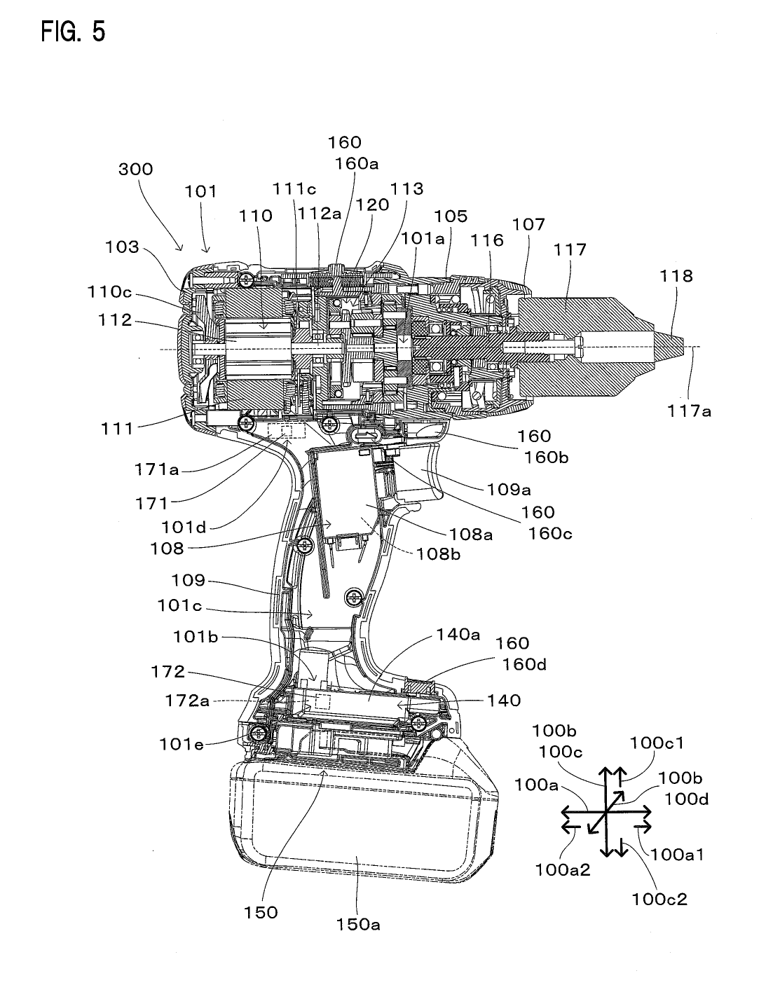

Representative embodiments of a power tool according to the present invention are now described with reference to FIGS. 1 to 5. FIGS. 1 to 3 are explanatory drawings of a first embodiment. FIG. 4 is an explanatory drawing of a second embodiment. FIG. 5 is an explanatory drawing of a third embodiment. In the embodiments of the present invention, a driver drill is explained as a representative example of a power tool. Further, in the second and third embodiments, parts and mechanisms having the same structure and function as in the first embodiment are given the same designations and numerals and they are not described herein.

### First Embodiment

FIG. 1 is a sectional view for illustrating the outline of a driver drill 100. As shown in FIG. 1, the driver drill 100 is a hand-held power tool having a handgrip 109 designed to be held by a user and configured such that a tool bit (not shown) coupled to a chuck 117 rotates coaxially with a rotation axis 117a of the chuck 117. The driver drill 100, the chuck 117 and the tool bit are example embodiments that correspond to the “power tool”, the “chuck” and the “tool accessory”, respectively, according to the present invention.

### Outline of the Driver Drill

The driver drill 100 has a driver mode in which a screw tightening operation is performed by rotation of the tool bit and a drill mode in which a drilling operation is performed on a workpiece by rotation of the tool bit. A user can select the driver mode or the drill mode by turning a mode changeover ring 107. For the sake of expedience, the mode changeover ring 107 and a mechanism connected to the mode changeover ring 107 are not described. The chuck 117 has a tool bit holding part 118. The tool bit is removably attached to the tool bit holding part 118 so that the tool bit (driver bit) for use in the driver mode and the tool bit (drill bit) for use in the drill mode can be replaced with each other.

The rotation axis 117a of the chuck 117 defines a longitudinal direction 100a of the driver drill 100. In the longitudinal direction 100a, the chuck 117 side defines a front side 100a1 and the driving motor 110 side defines a rear side 100a2. In a transverse direction 100b crossing the longitudinal direction 100a, a direction perpendicular to the longitudinal direction 100a and containing an extending component of the handgrip 109 defines a height direction 100c. In the height direction 100c, the side to which the handgrip 109 extends with respect to the driving motor 110 defines a lower side 100c2 and the side opposite to the lower side 100c2 defines an upper side 100c1. Further, in the transverse direction 100b, a direction perpendicular to both the longitudinal direction 100a and the height direction 100c defines a width direction 100d.

### Description of the Body

As shown in FIG. 1, the driver drill 100 has a body 101. The body 101 has a motor housing 103 in which the driving motor 110 is disposed, a gear housing 105 in which a speed reducing mechanism 113 is disposed, and the handgrip 109 designed to be held by a user. The body 101, the driving motor 110 and the speed reducing mechanism 113 are example embodiments that correspond to the “body”, the “driving motor” and the “power transmitting mechanism”, respectively, according to the present invention.

As shown in FIG. 1, the handgrip 109 has a trigger 109a which is operated by the user and the body 101 houses a switch 108 that is operated in conjunction with the trigger 109a. The trigger 109a and the switch 108 are example embodiments that correspond to the “trigger” and the “switch”, respectively, according to the present invention. The switch 108 has a switch housing 108a and a switch circuit board 108b which is housed in the switch housing 108a and on which components related to the switch 108 are mounted. The switch housing 108a and the switch circuit board 108b are example embodiments that correspond to the “switch housing” and the “switch circuit board”, respectively, according to the present invention. Further, transmission of signals to a controller 140 based on operation of the trigger 109a is technically performed by a component group which is mounted on the switch circuit board 108b. For the sake of convenience of explanation, however, in the embodiment of the present invention, transmission of signals to the controller 140 based on operation of the trigger 109a may be described as being performed by the “switch 108”.

The trigger 109a and the switch 108 form an essential part of a driving mechanism 120, which is described below, together with the driving motor 110, the speed reducing mechanism 113, a spindle 116 and the chuck 117. The driving mechanism 120 is an example embodiment that corresponds to the “driving mechanism” according to the present invention.

As shown in FIG. 1, the controller 140 is disposed on the lower side 100c2 of the handgrip 109. The controller 140 has a controller housing 140a and a controller circuit board 140b which is housed in the controller housing 140a and on which components related to the controller 140 are mounted. The controller 140, the controller housing 140a and the controller circuit board 140b are example embodiments that correspond to the “controller”, the “controller housing” and the “controller circuit board”, respectively, according to the present invention. An extending direction of the controller housing 140a in the longitudinal direction 100a is substantially parallel to the longitudinal direction 100a. Further, a prescribed control function of the controller 140 is technically performed by the component group mounted on the controller circuit board 140b. For the sake of convenience of explanation, however, in the embodiment of the present invention, the prescribed control function may be described as being performed by the “controller 140”.

As shown in FIG. 1, a battery mounting part 150 for mounting a battery 150a is provided on the lower side 100c2 of the controller 140.

As shown in FIG. 1, the body 101 has a driving mechanism housing region 101a for housing the driving mechanism 120 and a controller housing region 101b for housing the controller 140. The driving mechanism housing region 101a and the controller housing region 101b are example embodiments that correspond to the “driving mechanism housing region” and the “controller housing region”, respectively, according to the present invention.

Further, an intermediate region 101c is formed between the driving mechanism housing region 101a and the controller housing region 101b. The intermediate region 101c is designed as a region in which a wiring for electrically connecting the driving mechanism 120 and the controller 140 is disposed and on which a little finger and a ring finger of the user are mainly placed when the user holds the handgrip 109.

As shown in FIG. 1, the body 101 further has a first sensor 171 and a second sensor 172. The first and second sensors 171, 172 detect behavior of the body 101 during operation. The first sensor 171 and the second sensor 172 are example embodiments that correspond to the “first sensor” and the “second sensor”, respectively, according to the present invention. The first and second sensors 171, 172 are acceleration sensors, so that they can detect an inclination angle of the body 101 to the earth's axis. As described below, the controller 140 operates the results of detection of the first and second sensors 171, 172, so that the behavior of the body 101 during operation is detected.

The first sensor 171 is mounted on a first sensor substrate 171a and the second sensor 172 is mounted on a second sensor substrate 172a. The first sensor substrate 171a is an example embodiment that corresponds to the “first sensor substrate” according to the present invention.

In the driver drill 100, the first sensor 171 is mounted on a motor circuit board 111c of the driving motor 110 which is described below. Therefore, the motor circuit board 111c also serves as the first sensor substrate 171a. The motor circuit board 111c is an example embodiment that corresponds to the “motor circuit board” according to the present invention. Further, the second sensor 172 is mounted on a controller circuit board 140b. Therefore, the controller circuit board 140b also serves as the second sensor substrate 172a.

Further, in the body 101, a space in which the first sensor 171 is arranged forms a first sensor arrangement space 101d and a space in which the second sensor 172 is arranged forms a second sensor arrangement space 101e. The first sensor arrangement space 101d and the second sensor arrangement space 101e are formed in the driving mechanism housing region 101a and the controller housing region 101b, respectively. The first sensor arrangement space 101d is an example embodiment that corresponds to the “first sensor arrangement space” according to the present invention.

The driver drill 100 has an operation function part 160 for realizing various functions. As shown in FIG. 1, the operation function part 160 has a speed changeover switch 160a for changing the rotation speed of the driving motor 110, an illumination part 160b for emitting light during a prescribed period of time by operation of the trigger 109a, a rotating direction changeover switch 160c for changing the rotating direction of the driving motor 110, and a remaining battery charge display part 160d for displaying the remaining battery charge of the battery 150a. The speed changeover switch 160a, the illumination part 160b and the rotating direction changeover switch 160c are disposed in the driving mechanism housing region 101a, and the remaining battery charge display part 160d is disposed in the controller housing region 101b. Further, the controller 140 controls the operation function part 160.

### Structure of the Driving Mechanism

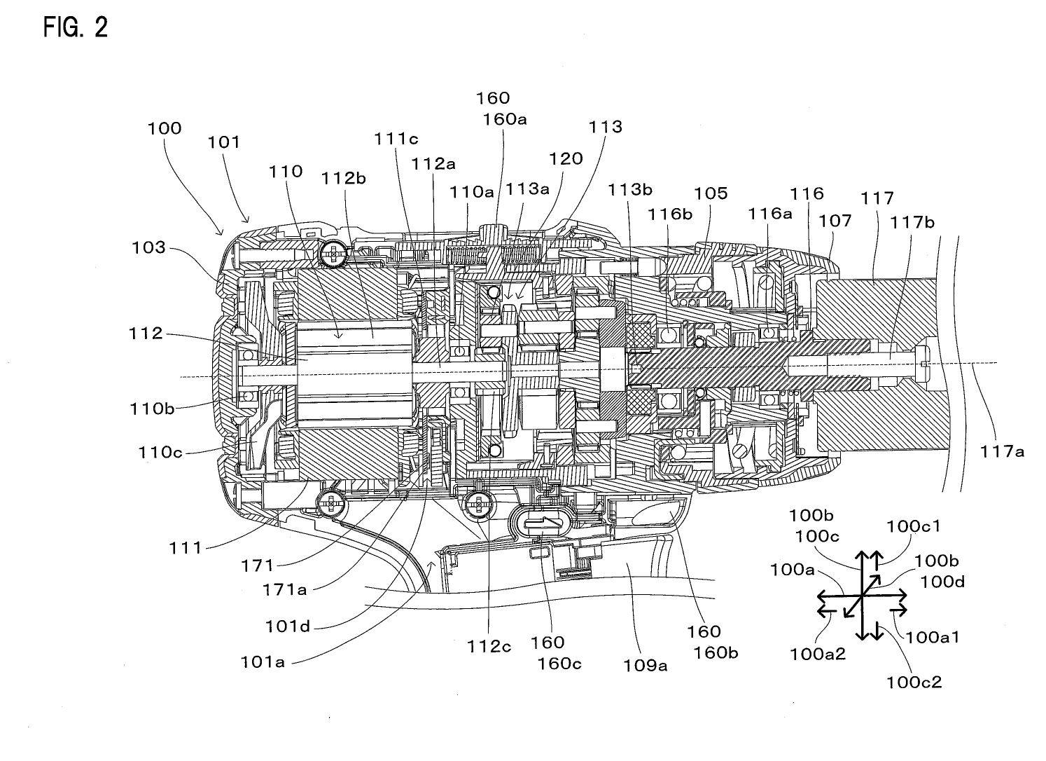

A structure of the driving mechanism 120 is now explained with reference to FIGS. 1 to 3. FIG. 2 is an enlarged view showing an essential part of the driving mechanism 120. As shown in FIG. 2, the driving motor 110 is a DC brushless motor. The driving motor 110 has a stator 111 and a rotor 112. The stator 111 and the rotor 112 are example embodiments that correspond to the “stator” and the “rotor”, respectively, according to the present invention.

The rotor 112 has a motor output shaft 112a and a magnet 112b. The motor output shaft 112a has a region which extends to the front side 100a1 from the magnet 112b and is supported by a front bearing 110a, and a region which extends to the rear side 100a2 from the magnet 112b and is supported by a rear bearing 110b. A pinion gear 112c is fitted onto a region of the motor output shaft 112a on the front side 100a1 of the front bearing 110a and engages with a driven gear 113a of the speed reducing mechanism 113. A fan 110c is fitted onto a region of the motor output shaft 112a between the rear bearing 110b and the magnet 112c and sends cooling air to the driving motor 110 by rotating together with the motor output shaft 112a. The magnet 112b is an example embodiment that corresponds to the “magnet” according to the present invention.

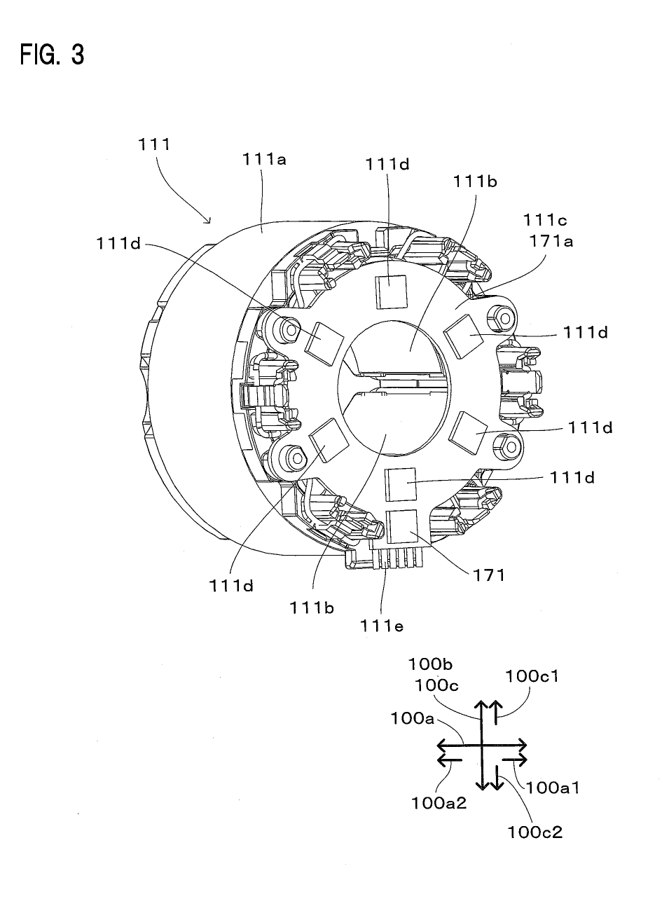

FIG. 3 is an explanatory drawing for illustrating the structure of the stator 111. As shown in FIG. 3, the stator 111 is cylindrically shaped and has a stator case 111a for housing the magnet 112b of the rotor 112. Coil elements are disposed in a position of the stator case 111a which faces the magnet 112b. The coil elements are six coils 111b having the same structure and arranged at equal intervals on an inner circumferential side of the stator case 111a. The coil 111b is an example embodiment that corresponds to the “coil” according to the present invention. The motor circuit board 111c is disposed on the front side 100a1 of the stator case 111a. A rotation detecting element (not shown) is disposed on the rear side 100a2 of the motor circuit board 111c and detects positional information of the magnet 112b when the rotor 112 is rotated. Further, six switching elements 111d are disposed on the front side 100a1 of the motor circuit board 111c and electrically connected to the six coils 111b. The switching element 111d is an example embodiment that corresponds to the “switching element” according to the present invention. The switching element 111d is a field effect transistor (FET). Further, the motor circuit board 111c is provided with a terminal 111e for electric connection with the controller circuit board 140b. With this structure, the controller 140 acquires the rotating condition of the rotor 112 based on the positional information of the magnet 112b of the rotor 112 which is detected by the rotation detecting element, and supplies a signal to the switching element 111d so as to supply current to each coil 111b in a prescribed order. In this manner, the controller 140 controls rotation of the rotor 112.

As shown in FIG. 3, the first sensor 171 is disposed on the front side 100a1 of the motor circuit board 111c. Specifically, it is made unnecessary to provide a special structure for mounting the first sensor 171 by providing the first sensor substrate 171a as the motor circuit board 111c which is an essential component of the brushless motor. With this structure, the body 101 can be prevented from being increased in size.

As shown in FIG. 2, rotation of the driving motor 110 is transmitted to the speed reducing mechanism 113 in the form of a planetary gear mechanism via the pinion gear 112c fitted onto the motor output shaft 112a and the driven gear 113a. Rotation of a speed reducing mechanism output shaft 113b of the speed reducing mechanism 113 is transmitted to the chuck 117 via the spindle 116. The spindle 116 is rotatably supported by the front bearing 116a and the rear bearing 116b. The spindle 116 and the chuck 117 are integrally connected with each other by a screw 117b.

With the above-described structure, the driving mechanism 120 can transmit rotation of the driving motor 110 to the chuck 117 and rotate the tool accessory.

As shown in FIG. 1, the driving motor 110 is disposed in the body 101 on the rear side 100a2 with respect to the handgrip 109. Further, in the driving mechanism 120, the driving motor 110, the speed reducing mechanism 113 and the tool bit are arranged in this order from the rear side 100a2 to the front side 100a1. In this case, the rotation axis of the driving motor 110, the rotation axis of the speed reducing mechanism output shaft 113b and the rotation axis 117a of the chuck 117 are aligned in a line. This structure makes it possible to provide the driving mechanism 120 in a compact form, and thus can advantageously reduce the size of the driver drill 100. Further, a specific technique is desired in order to secure the first sensor arrangement space 101d. Therefore, the driver drill 100 is configured such that the first sensor arrangement space 101d is secured on the motor circuit board 111c by forming the motor circuit board 111c as the first sensor substrate 171a. With this structure, the first sensor 171 is arranged such that the driver drill 100 can be prevented from being increased in size.

Further, as shown in FIG. 1, the second sensor 172 is mounted on the controller circuit board 140b. Therefore, the second sensor arrangement space 101e can be secured inside the controller housing 140a, so that the second sensor 172 is arranged such that the driver drill 100 can be prevented from being increased in size.

### Description of Operation of the Driver Drill

Control operation of the driver drill 100 at the time of occurrence of a blocking phenomenon is now explained. First, the structure of the controller 140 relating to this control operation is explained. Components forming a central processing unit (CPU) are mounted on the controller circuit board 140b. The central processing unit is configured to discriminate between a stable state in which the driver drill 100 performs the operation with stability and an unstable state and de-energize the driving motor 110 when the driver drill 100 is in the unstable state. More specifically, the central processing unit has a storage part, a comparison operation part and a current shutoff part. The storage part stores information relating to signals to be detected in the stable state by the first and second sensors 171, 172. The comparison operation part compares signals obtained from the first and second sensors 171, 172 during operation with the information of the storage part and determines whether the driver drill 100 is in the stable state or in the unstable state. The current shutoff part de-energizes the driving motor 110 when the comparison operation part determines that the driver drill 100 is in the unstable state.

Operation of the driver drill 100 in the drill mode is now explained. In the drill mode, the user holds the handgrip 109 and presses the drill bit against a workpiece. Then, when the user operates the trigger 109a, the motor circuit board 111c is energized and the driving motor 110 is rotationally driven. When the motor circuit board 111c is energized, the first sensor 171 is turned on. In other words, when the trigger 109a is not operated, the first sensor 171 is kept in the off state. With this structure, power consumption of the battery 150a can be reduced.

When the user performs a drilling operation in the stable state, the drill bit drills the workpiece, so that the body 101 proceeds to the front side 100a1 along the longitudinal direction 100a. In this case, the controller 140 operates the acceleration detected by the first sensor 171 and the acceleration detected by the second sensor 172 via the comparison operation part, determines that the behavior of the body 101 is in the stable state, and maintains the driving state of the driving motor 110.

On the other hand, when the drill bit causes the blocking phenomenon, the body 101 is rotated around the rotation axis 117a, so that each of the first and second sensors 171, 172 detects the acceleration. At this time, the first sensor 171 detects the acceleration of a different value from that in the stable state. Further, with the structure in which the second sensor 172 is arranged at a position further away from the rotation axis 117a than the first sensor 171, the acceleration detected by the second sensor 172 is larger than that detected by the first sensor 171. In such a state, the comparison operation part operates the accelerations obtained by the first and second sensors 171, 172 and compares them with the information of the storage part. As a result, the comparison operation part determines that the body 101 is in a wobbling state (in the unstable state) and de-energizes the driving motor 110 via the current shutoff part. In this manner, the time of wobbling of the driver drill 100 which is caused by the blocking phenomenon can be shortened.

If a single sensor is provided to detect the behavior of the body 101, it may be difficult to discriminate between parallel movement of the body 101 in the width direction 100d and wobbling of the body 101.

In the driver drill 100 according to the first embodiment, the first sensor 171 and the second sensor 172 are disposed in the driving mechanism housing region 101a and the controller housing region 101b, respectively. Specifically, the first sensor 171 is disposed in a position closer to the rotation axis 117a than the second sensor 172. In other words, the second sensor 172 is disposed in a position further away from the rotation axis 117a than the first sensor 171. Therefore, for example, as described above, when the body 101 rotates around the rotation axis 117a, the difference between the acceleration detected by the first sensor 171 and the acceleration detected by the second sensor 172 becomes larger, so that the accuracy of detection of the behavior of the body 101 during operation can be improved.

The above-described control operation of the driving motor 110 upon detection of the behavior of the body 101 can also be performed in the driver mode of the driver drill 100.

Further, the blocking phenomenon is less likely to cause in the driver mode than in the drill mode. Therefore, the driver drill 100 can be configured to perform the control operation of the driving motor 110 upon detection of the behavior of the body 101 in the drill mode and not to perform the control operation in the driver mode. With this structure, the power consumption of the battery 150a can be reduced.

### Second Embodiment

A structure of a driver drill 200 according to a second embodiment of the present invention is now explained with reference to FIG. 4. FIG. 4 is a sectional view for illustrating the outline of the driver drill 200. The driver drill 200 is an example embodiment that corresponds to the “power tool” according to the present invention.

The driver drill 200 is different from the above-described driver drill 100 in the arrangement of the first sensor 171. Specifically, the first sensor 171 of the driver drill 200 is mounted on the switch circuit board 108b. With this structure, the switch circuit board 108b also serves as the first sensor substrate 171a and the first sensor arrangement space 101d is formed within the switch housing 108a.

With this structure, in the driver drill 200, the first and second sensors 171, 172 can be disposed while the body 101 can be prevented from being increased in size. Further, like the above-described driver drill 100, the driver drill 200 can detect the behavior of the body 101 during operation and control the driving motor 110.

### Third Embodiment

A structure of a driver drill 300 according to a third embodiment of the present invention is now explained with reference to FIG. 5. FIG. 5 is a sectional view for illustrating the outline of the driver drill 300. The driver drill 300 is an example embodiment that corresponds to the “power tool” according to the present invention.

The driver drill 300 is different from the above-described driver drill 100 in the arrangement of the first sensor 171. Specifically, the first sensor 171 of the driver drill 300 is disposed in a prescribed space formed between the driving motor 110 and the switch 108 in the body 101. In other words, the prescribed space forms the first sensor arrangement space 101d. The prescribed space has an existing structure in the driver drill 300 where the driving motor 110 is arranged on the rear side 100a2 with respect to the handgrip 109, where the driving motor 110, the speed reducing mechanism 113 and the tool bit are arranged in this order from the rear side 100a2 to the front side 100a1, and where the rotation axis of the driving motor 110, the rotation axis of the speed reducing mechanism output shaft 113b and the rotation axis 117a of the chuck 117 are aligned in a line. In the driver drill 300, the prescribed space having the existing structure is configured as the first sensor arrangement space 101d, so that the first and second sensors 171, 172 can be disposed while the body 101 can be prevented from being increased in size. Further, like the above-described driver drill 100, the driver drill 300 can detect the behavior of the body 101 during operation and control the driving motor 110.

The first sensor 171 and components necessary for driving the first sensor 171 are mounted on a printed circuit board. Specifically, the printed circuit board forms the first sensor substrate 171a. Further, only the first sensor 171 and components necessary for driving the first sensor 171 are mounted on the first sensor substrate 171a, so that size reduction of the first sensor substrate 171a can be realized. Thus, the first sensor arrangement space 101d can be prevented from being increased in size.

The power tool according to the present invention is not limited to the above-described structures. For example, the behavior to be detected is explained as wobbling of the body 101 caused by a blocking phenomenon, but it is not limited to this movement.

Further, the first sensor 171 may be disposed in any position of the driving mechanism housing region 101a. For example, the first sensor 171 may be mounted on a printed circuit board of the speed changeover switch 160a, the illumination part 160b or the rotating direction changeover switch 160c.

In view of the nature of the above-described invention, the power tool according to this invention can be provided with the following features. Each of the features can be used separately or in combination with the other, or in combination with the claimed invention.

### Aspect 1

The power tool has a drill mode in which a drilling operation is performed on a workpiece and a driver mode in which a screw tightening operation is performed on a workpiece, and the controller detects the behavior of the body by the first sensor and the second sensor in the drill mode.

### Aspect 2

The power tool has a drill mode in which a drilling operation is performed on a workpiece and a driver mode in which a screw tightening operation is performed on a workpiece, and the controller detects the behavior of the body by the first sensor and the second sensor in both the drill mode and the driver mode.

### Aspect 3

The first sensor is energized by operation of the trigger.

### Aspect 4

In the body,

a rear end part of the driving motor is arranged on a rear side with respect to the handgrip,

the driving motor, the speed reducing mechanism and the tool accessory are arranged in this order from the rear side to the front side, and

a rotation axis of the driving motor, a rotation axis of a speed reducing mechanism output shaft and a rotation axis of the chuck are aligned in a line.

### Correspondences Between the Features of the Embodiments and the Features of the Invention

The above-described embodiments are representative examples for embodying the present invention, and the present invention is not limited to the structures that have been described as the representative embodiments. Correspondences between the features of the embodiments and the features of the invention are as follow:

The driver drill 100, 200, 300 is an example embodiment that corresponds to the “power tool” according to the present invention. The chuck 117 is an example embodiment that corresponds to the “chuck” according to the present invention. The tool bit is an example embodiment that corresponds to the “tool accessory” according to the present invention. The body 101 is an example embodiment that corresponds to the “body” according to the present invention. The driving motor 110 is an example embodiment that corresponds to the “driving motor” according to the present invention. The speed reducing mechanism 113 is an example embodiment that corresponds to the “power transmitting mechanism” according to the present invention. The trigger 109a is an example embodiment that corresponds to the “trigger” according to the present invention. The switch 108 is an example embodiment that corresponds to the “switch” according to the present invention. The switch housing 108a is an example embodiment that corresponds to the “switch housing” according to the present invention. The switch circuit board 108b is an example embodiment that corresponds to the “switch circuit board” according to the present invention. The driving mechanism 120 is an example embodiment that corresponds to the “driving mechanism” according to the present invention. The controller 140 is an example embodiment that corresponds to the “controller” according to the present invention. The controller housing 140a is an example embodiment that corresponds to the “controller housing” according to the present invention. The controller circuit board 140b is an example embodiment that corresponds to the “controller circuit board” according to the present invention. The first sensor 171 is an example embodiment that corresponds to the “first sensor” according to the present invention. The second sensor 172 is an example embodiment that corresponds to the “second sensor” according to the present invention. The driving mechanism housing region 101a is an example embodiment that corresponds to the “driving mechanism housing region” according to the present invention. The controller housing region 101b is an example embodiment that corresponds to the “controller housing region” according to the present invention. The first sensor substrate 171a is an example embodiment that corresponds to the “first sensor substrate” according to the present invention. The motor circuit board 111c is an example embodiment that corresponds to the “motor circuit board” according to the present invention. The first sensor arrangement space 101d is an example embodiment that corresponds to the “first sensor arrangement space” according to the present invention. The stator 111 is an example embodiment that corresponds to the “stator” according to the present invention. The rotor 112 is an example embodiment that corresponds to the “rotor” according to the present invention. The magnet 112b is an example embodiment that corresponds to the “magnet” according to the present invention. The coil 111b is an example embodiment that corresponds to the “coil” according to the present invention. The switching element 111d is an example embodiment that corresponds to the “switching element” according to the present invention.

### DESCRIPTION OF NUMERALS

100, 200, 300 driver drill (power tool)
100a longitudinal direction
100a1 front side
100a2 rear side
100b transverse direction
100c height direction
100c1 upper side
100c2 lower side
100d width direction
101 body
101a driving mechanism housing region
101b controller housing region
101c intermediate region
101d first sensor arrangement region
101e second sensor arrangement region
103 motor housing
105 gear housing
107 mode changeover ring
108 switch
108a switch housing
108b switch circuit board
109 handgrip
109a trigger
110 driving motor
110a front bearing
110b rear bearing
110c fan
111 stator
111a stator case
111b coil
111c motor circuit board
111d switching element
111e terminal
112 rotor
112a motor output shaft
112b magnet
112c pinion gear
113 speed reducing mechanism (power transmitting mechanism)
113a driven gear
113b speed reducing mechanism output shaft
116 spindle
116a front bearing
116b rear bearing
117 chuck
117a rotation axis
117b screw
118 tool bit holding part
120 driving mechanism
140 controller
140a controller housing
140b controller circuit board
150 battery mounting part
150a battery
160 operation function part
160a speed changeover switch
160b illumination part
160c rotating direction changeover switch
160d remaining battery charge display part
171 first sensor
171a first sensor substrate
172 second sensor
172a second sensor substrate

What we claim is:

1. A power tool which performs a prescribed operation by rotationally driving a tool accessory, comprising:
a driving mechanism including a chuck that can rotate while holding the tool accessory, a driving motor, a power transmitting mechanism that transmits rotation of the driving motor to the chuck, and a switch that is operated via a trigger which is manually operated by a user,
a controller for controlling the driving motor,
a body that has a driving mechanism housing region to house the driving mechanism and a controller housing region to house the controller,
a first sensor for detecting prescribed behavior of the body and
a second sensor for detecting prescribed behavior of the body,
wherein the first sensor is disposed in the driving mechanism housing region and the second sensor is disposed in the controller housing region.

2. The power tool as defined in claim 1, wherein the controller has a controller housing that houses a controller circuit board, and the second sensor is housed in the controller housing.

3. The power tool as defined in claim 1, wherein:
the driving motor is provided with a brushless motor,
the brushless motor includes a stator having a coil, a rotor that can rotate with respect to the stator and has a magnet, and a motor circuit board,
the motor circuit board is provided on the stator, and a rotation detecting element for detecting a position of the magnet and a switching element for supplying current to the coil based on a detection result of the rotation detecting element are mounted on the motor circuit board, and
the first sensor is mounted on the motor circuit board.

4. The power tool as defined in claim 1, wherein the switch has a switch housing that houses a switch circuit board, and the first sensor is housed in the switch housing.

5. The power tool as defined in claim 1, wherein:
the first sensor is disposed within a first sensor arrangement space formed between the switch and the power transmitting mechanism.

6. The power tool as defined in claim 1, wherein:
the first sensor is mounted on a first sensor substrate.

7. The power tool as defined in claim 1, wherein:
the first sensor and the second sensor respectively detect the accelerations of the body with respect to the rotation of the body around the rotation axis of the chuck,
the controller determines a blocking phenomenon of the body based on the detected respective accelerations to control the driving motor.

8. The power tool as defined in claim 1, wherein the second sensor is disposed remoter than the first sensor from the rotation axis of the chuck with respect to the direction crossing the rotation axis.

9. The power tool as defined in claim 1, further comprising a handgrip coupled to the body, wherein the controller housing region is disposed at a remote end of the handgrip from the body.

10. The power tool as defined in claim 1, wherein the first sensor is energized by operation of the trigger.
